(19) United States
(12) Patent Application Publication
(10) Pub. No.: US 2024/0413350 A1
(43) Pub. Date: Dec. 12, 2024

(54) BATTERY

(71) Applicant: TOYOTA JIDOSHA KABUSHIKI KAISHA, Toyota-shi (JP)

(72) Inventor: Sadao FUJISAKI, Toyota-shi (JP)

(73) Assignee: TOYOTA JIDOSHA KABUSHIKI KAISHA, Toyota-shi (JP)

(21) Appl. No.: 18/796,518

(22) Filed: Aug. 7, 2024

(30) Foreign Application Priority Data
Jun. 11, 2023 (JP) 2023-189143

(51) Int. Cl. H01M 4/70; H01M 10/0562

(52) U.S. Cl. CPC H01M 4/70; H01M 10/0562

(57) ABSTRACT

A battery is a battery comprising an electrode laminated body, in which: end-surface current collectors are disposed on both surfaces of the electrode laminated body in a lamination direction; an internal current collector is laminated in the interior of the electrode laminated body; the internal current collector includes a connection portion that is drawn out from a side surface of the electrode laminated body; and the connection portion extends along the side surface of the electrode laminated body in the lamination direction, and is disposed on an identical surface to a surface on which at least one of the end-surface current collectors is disposed.

### CROSS-REFERENCE TO RELATED APPLICATION

This application claims priority to Japanese Patent Application No. 2023-189143 filed on Nov. 6, 2023, incorporated herein by reference in its entirety.

### BACKGROUND

### 1. Technical Field

The present application relates to a battery.

### 2. Description of Related Art

Japanese Unexamined Patent Application Publication No. 2019-53845 (JP 2019-53845 A) discloses a current collecting plate disposition structure for a bipolar battery in which a voltage monitoring terminal (current collecting plate) extends along a lamination direction between an outer surface of a side-wall sealing material or a battery cell laminated body and the side-wall sealing material and an end portion of the voltage monitoring terminal is disposed on an upper surface of an upper-wall sealing material. JP 2019-53845 A describes that the occupation area of the voltage monitoring terminal on a cell side surface can be reduced because the voltage monitoring terminal is disposed on the upper surface of the upper-wall sealing material.

### SUMMARY

However, the current collecting plate disposition structure in JP 2019-53845 A requires an outer packaging member having a through-hole through which the voltage monitoring terminal is drawn out to the outside, and the structure of the outer packaging member is restricted.

Hence, in view of the above circumstance, a main object of the present disclosure is to provide a battery that makes it possible to enhance structural efficiency in a simple structure.

The present disclosure provides at least the following aspects.

A first aspect is a battery including an electrode laminated body, in which: end-surface current collectors are disposed on both surfaces of the electrode laminated body in a lamination direction; an internal current collector is laminated in the interior of the electrode laminated body; the internal current collector includes a connection portion that is drawn out from a side surface of the electrode laminated body; and the connection portion extends along the side surface of the electrode laminated body in the lamination direction, and is disposed on an identical surface to a surface on which at least one of the end-surface current collectors is disposed.

A second aspect is the battery according to the first aspect, in which: a plurality of the internal current collectors is laminated in the interior of the electrode laminated body; and connection portions that are drawn out from the plurality of the internal current collectors are disposed at such positions that the connection portions do not overlap with each other in lamination-directional view.

A third aspect is the battery according to the first or second aspect, in which: the connection portion is disposed on the at least one of the end-surface current collectors such that an end-surface insulation layer is interposed; and the connection portion and the at least one of the end-surface current collectors are insulated by the end-surface insulation layer.

A fourth aspect is the battery according to any one of the first to third aspects, in which: a side-surface insulation layer is disposed on at least one of an extension portion and the side surface of the electrode laminated body, the extension portion being a portion that is of the connection portion and that extends along the side surface of the electrode laminated body in the lamination direction; and the connection portion and the side surface of the electrode laminated body are insulated by the side-surface insulation layer.

The battery in the present disclosure makes it possible to enhance structural efficiency in a simple structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a battery 100;

FIG. 2 is an elevational view of the battery 100 as viewed from the direction of II in

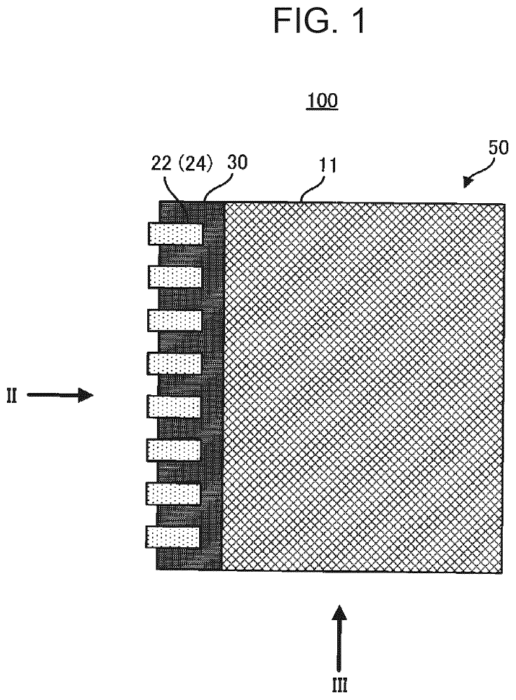

FIG. 1;

FIG. 3 is a side view of the battery 100 as viewed from the direction of III in FIG. 1;

FIG. 4A is a plan view of an internal current collector 20;

FIG. 4B is a diagram showing a plurality of internal current collectors 20 for describing differences in the position and length of a connection portion 22; and

FIG. 5 is a sectional view of an electrode laminated body 50 that is an example.

### DETAILED DESCRIPTION OF EMBODIMENTS

A battery in the present disclosure will be described with use of a battery 100 that is an embodiment.

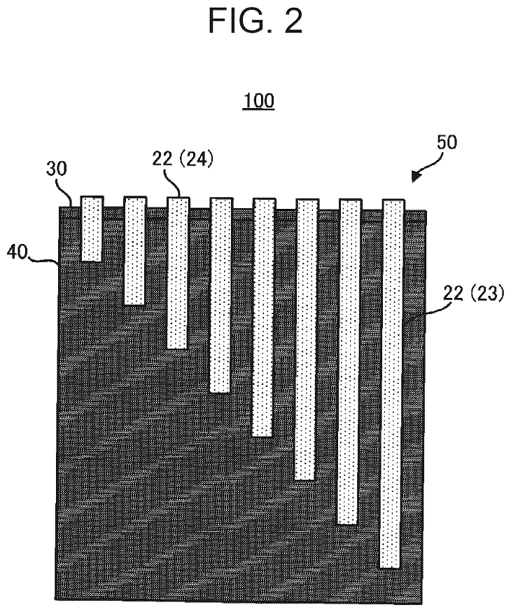

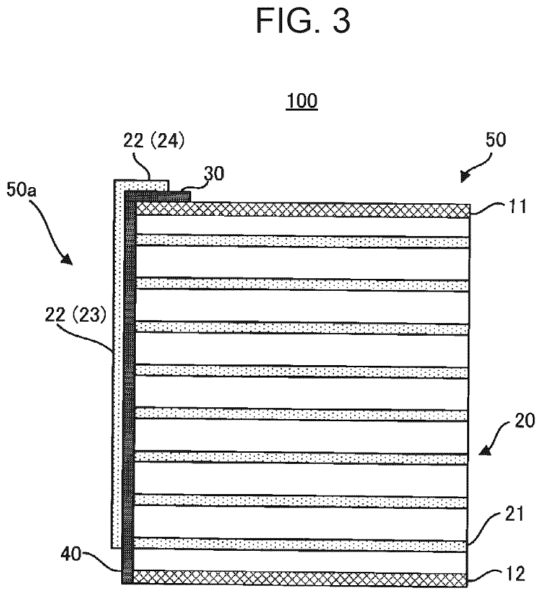

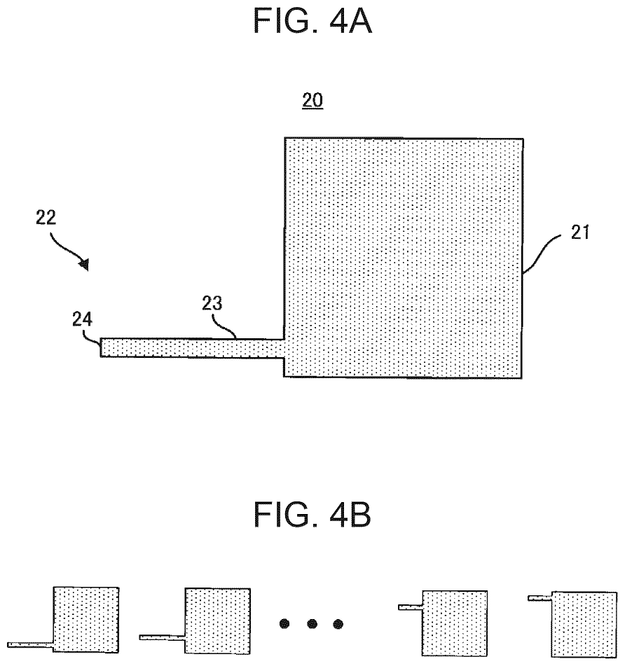

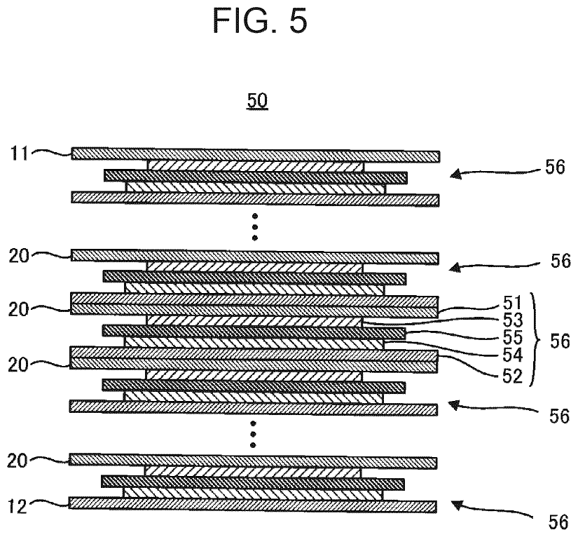

FIG. 1 shows a plan view of the battery 100. FIG. 2 shows an elevational view as viewed from the direction of II in FIG. 1. FIG. 3 is a side view of the battery 100 as viewed from the direction of III in FIG. 1.

The battery 100 includes an electrode laminated body 50.

### Electrode Laminated Body 50

The electrode laminated body 50 is a laminated body that has a rectangular shape in lamination-directional view and that includes current collectors (a positive electrode current collector and a negative electrode current collector), a positive electrode layer, a negative electrode layer, and an electrolyte layer. In the electrode laminated body 50, the number of laminated layers is not particularly limited, and may be appropriately set depending on purpose. The lamination form of the electrode laminated body 50 is not particularly limited, and may be a monopolar type, or may be a bipolar type. The electrode laminated body 50 may be a liquid state battery, or may be a solid state battery. The electrode laminated body 50 may be a lithium-ion battery, may be a sodium-ion battery, or may be a nickel-hydrogen battery, or the like. The electrode laminated body 50 may be a primary battery, or may be a secondary battery.

### Material of Electrode Laminated Body 50

The materials of the respective layers that constitute the electrode laminated body 50 will be described with typical examples. However, the materials of the respective layers that constitute the electrode laminated body 50 are not limited to the typical examples.

The current collector is a sheet-shaped conductive member. Examples of the current collector include a metal foil composed of stainless steel, iron, copper, aluminum, titanium, nickel, or the like. The metal foil may be composed of an alloy that contains two or more kinds of these metals. Further, for the metal foil, a predetermined surface treatment such as plating may be performed. The current collector may be constituted by a plurality of metal foils. In this case, the metal foils may be united by an adhesive or the like, or may be united by pressing or the like. The shape of the current collector may be a rectangular shape. The thickness of the current collector is not particularly limited, and is 1 μm to 1 mm, for example.

The positive electrode layer contains at least a positive electrode active material. The positive electrode active material is not particularly limited, and an arbitrary material may be appropriately selected depending on intended battery performance. For example, there are a composite oxide, a metallic lithium, sulfur, and the like. For example, the composition of the composite oxide includes at least one of iron, manganese, titanium, nickel, cobalt, and aluminum, and lithium. Examples of the composite oxide include olivine lithium iron phosphate (LiFePO₄).

The positive electrode layer may arbitrarily contain a conductive auxiliary agent. The conductive auxiliary agent is not particularly limited, and an arbitrary material may be appropriately selected depending on intended battery performance. For example, there are carbon materials such as acetylene black, carbon black, and graphite.

The positive electrode layer may arbitrarily contain a binding agent. The binding agent is not particularly limited, and an arbitrary material may be appropriately selected depending on intended battery performance. For example, there are a rubber resin, a fluoride resin, and the like.

The positive electrode layer may arbitrarily contain a solid electrolyte. The solid electrolyte is not particularly limited, and an arbitrary material may be appropriately selected depending on intended battery performance. For example, there are a solid oxide electrolyte, a solid sulfide electrolyte, and the like.

The positive electrode layer may have a rectangular shape. The thickness of the positive electrode layer is not particularly limited, and is in a range of 1 μm to 1 mm, for example. The area of the positive electrode layer may be smaller than the area of the negative electrode layer. The content of each material in the positive electrode layer is not particularly limited, and may be appropriately set depending on intended battery performance. The positive electrode layer may contain materials other than the above materials.

The negative electrode layer contains a negative electrode active material. The negative electrode active material is not particularly limited, and an arbitrary material may be appropriately selected depending on intended battery performance. For example, there are a carbon material such as black lead, artificial black lead, hard carbon, and soft carbon, a metallic compound, an element that can alloy together with lithium, a compound of the element that can alloy together with lithium, and the like. Examples of the element 10 that can alloy together with lithium include silicon and tin.

The negative electrode layer may arbitrarily contain a conductive auxiliary agent. The conductive auxiliary agent is not particularly limited, and an arbitrary material may be appropriately selected depending on intended battery performance. For example, a conductive auxiliary agent that can be applied to the positive electrode layer may be appropriately selected.

The negative electrode layer may arbitrarily contain a binding agent. The binding agent is not particularly limited, and an arbitrary material may be appropriately selected depending on intended battery performance. For example, a binding agent that can be applied to the positive electrode layer may be appropriately selected.

The negative electrode layer may arbitrarily contain a solid electrolyte. The solid electrolyte is not particularly limited, and an arbitrary material may be appropriately selected depending on intended battery performance. For example, a solid electrolyte that can be applied to the positive electrode layer may be appropriately selected.

The negative electrode layer may have a rectangular shape. The thickness of the negative electrode layer is not particularly limited, and is in a range of 1 μm to 1 mm, for example. From a standpoint of output enhancement, the area of the negative electrode layer may be larger than the area of the positive electrode layer. The content of each material in the negative electrode layer is not particularly limited, and may be appropriately set depending on intended battery performance. The negative electrode layer may contain materials other than the above materials.

In the case where the electrolyte layer is a liquid electrolyte layer, the electrolyte layer contains a separator and an electrolytic solution. The separator is mainly a porous polyolefin sheet. The electrolytic solution is a solution in which a supporting electrolyte is dissolved in a nonaqueous solvent. As the nonaqueous solvent, there are carbonate solvents, ether solvents, ester solvents, and the like. As the supporting electrolyte, for example, there are LiPF₆, LiBF₄, lithium bis (fluorosulfonyl) imide (LiFSI), lithium bis (trifluoromethane) sulfonimide (LiTFSI), and the like.

In the case where the electrolyte layer is a solid electrolyte layer, the electrolyte layer contains a solid electrolyte. Further, the solid electrolyte layer may contain a binding agent. The solid electrolyte and the binding agent may be appropriately selected from the above-described solid electrolytes and bonding agents.

The electrolyte layer may have a rectangular shape. The thickness of the electrolyte layer is not particularly limited, and is in a range of 1 μm to 1 mm, for example.

### End-Surface Current Collectors 11, 12, Internal Current Collector 20

As shown in FIG. 1 to FIG. 3, current collectors (also referred to as “end-surface current collectors 11, 12” in the present specification) are disposed on both surfaces of the electrode laminated body 50 in the lamination direction. Further, in the interior of the electrode laminated body 50, current collectors (also referred to as “internal current collector 20” in the present specification) are laminated.

The end-surface current collectors 11, 12 are disposed on both end surfaces of the electrode laminated body 50 in the lamination direction. Each of the end-surface current collectors 11, 12 may be a positive electrode current collector, or may be a negative electrode current collector. Further, the end-surface current collectors 11, 12 may be an identical kind of current collector, or may be different kinds of current collectors. Typically, the end-surface current collectors 11, 12 are different kinds of current collectors.

The internal current collectors 20 are laminated in the interior of the electrode laminated body 50. The number of internal current collectors 20 is not particularly limited, and may be appropriately set depending on purpose. In FIG. 1 to FIG. 3, a plurality of internal current collectors 20 (eight internal current collectors 20) is disposed in the interior of the electrode laminated body 50. The internal current collectors 20 may be positive electrode current collectors, or may be negative electrode current collectors. Further, the internal current collectors 20 may be an identical kind of current collectors, or may be different kinds of current collectors. The internal current collectors 20 play a role in providing battery information to the exterior, as described later, and therefore, all internal current collectors 20 may be constituted by an identical kind of current collectors (preferably, positive electrode current collectors). Further, the electrode laminated body 50 may include, in the interior, an ordinary current collector other than the internal current collectors 20.

As a characteristic, the internal current collector 20 includes a connection portion 22 that is drawn out from a side surface of the electrode laminated body 50, unlike the other current collectors. FIG. 4A shows a plan view of the internal current collector 20, and FIG. 4B shows a plurality of internal current collectors 20 for describing differences in the position of the connection portion 22.

As shown in FIG. 4A, the internal current collector 20 includes a main body portion 21 and the connection portion 22. The main body portion 21 is a portion that is laminated in the interior of the electrode laminated body 50 and that has a function as a current collector. Accordingly, on the main body portion 21, the positive electrode layer or negative electrode layer is laminated. The main body portion 21 has a rectangular shape. On the other hand, the connection portion 22 is a portion for providing the battery information (information about voltage, electric current, and the like) to the exterior, and has an elongated belt shape. For example, the connection portion 22 is used as a voltage monitoring line. As shown in FIG. 1 to FIG. 3, the connection portion 22 is formed so as to be drawn out from a side surface 50a of the electrode laminated body 50, and the drawn-out connection portion 22 is folded in the lamination direction. Moreover, the connection portion 22 is further folded, and an end portion of the connection portion 22 is disposed on the identical surface to the surface on which the end-surface current collector 11 is disposed. In this way, the connection portion 22 is characterized in that the connection portion 22 extends along the side surface 50a of the electrode laminated body 50 in the lamination direction and is disposed on the identical surface to the surface on which the end-surface current collector 11 is disposed.

Conventional batteries have a shape in which the connection portion to function as the voltage monitoring line is merely drawn out in a side surface direction. On the other hand, in the battery 100, the connection portion 22 has a portion (a later-described extension portion 23) that extends along the side surface 50a of the electrode laminated body 50 in the lamination direction, and thereby, it is possible to reduce the area of the connection portion 22 on the whole of the battery 100. Further, in JP 2019-53845 A, an outer packaging member having a through-hole through which the voltage monitoring terminal is drawn out to the outside is required, and the structure of the outer packaging member is restricted. On the other hand, in the battery 100, the connection portion 22 (a later-described end portion 24) is disposed on the identical surface to the surface on which the end-surface current collector 11 is disposed, and thereby, it is possible to enhance structural efficiency in a simple structure.

In the connection portion 22, a portion that is drawn out from the side surface of the electrode laminated body 50 and that extends along the side surface 50a in the lamination direction is referred to as the extension portion 23, and a portion that is disposed on the identical surface to the surface on which the end-surface current collector 11 is disposed is referred to as the end portion 24.

As shown in FIG. 4B, the position of the connection portion 22 in the internal current collector 20 is not particularly limited, but as shown in FIG. 1 and FIG. 2, the connection portions 22 drawn out from the plurality of internal current collectors 20 may be disposed at such positions that the connection portions 22 do not overlap with each other in lamination-directional view. Thereby, it is possible to restrain the contact among the connection portions 22, and to simplify the battery structure. Further, as shown in FIG. 4B, the length of the connection portion 22 may be arbitrarily set depending on the position of the end portion 24.

Here, “the connection portion 22 is disposed on the identical surface to the surface on which the end-surface current collector 11 is disposed” will be further described. As shown in FIG. 1 and FIG. 3, the end portion 24 of the connection portion 22 is disposed on the end-surface current collector 11 such that an end-surface insulation layer 30 is interposed. Therefore, strictly speaking, the end portion 24 of the connection portion 22 is not disposed on the identical surface to the surface on which the end-surface current collector 11 is disposed. However, the end-surface insulation layer 30 is a very thin layer, and therefore, it can be said that the end portion 24 of the connection portion 22 and the end-surface current collector 11 are disposed on the identical surface, from a standpoint of use. Accordingly, “the connection portion 22 is disposed on the identical surface to the surface on which the end-surface current collector 11 is disposed” does not strictly mean that the end portion 24 of the connection portion 22 is disposed on the identical surface to the surface on which the end-surface current collector 11 is disposed, and means that the end portion 24 of the connection portion 22 only needs to be disposed on the identical surface to the surface on which the end-surface current collector 11 is disposed from a standpoint of use.

In the electrode laminated body 50, the connection portion 22 is disposed on the identical surface to the surface on which the end-surface current collector 11 is disposed, but the present disclosure is not limited to this. The connection portion 22 may be disposed on the identical surface to the surface on which the end-surface current collector 12 is disposed. Further, some of the plurality of connection portions 22 may be disposed on the identical surface to the surface on which the end-surface current collector 11 is disposed, and the other of the plurality of connection portions 22 may be disposed on the identical surface to the surface on which the end-surface current collector 12 is disposed. Accordingly, each connection portion 22 may extend along the side surface 50a of the electrode laminated body 50 in the lamination direction, and may be disposed on the identical surface to the surface on which at least one of the end-surface current collectors 11, 12 is disposed.

### Lamination Form of Electrode Laminated Body 50

As described above, the electrode laminated body 50 is a laminated body that includes the current collectors, the positive electrode layer, the electrolyte layer, and the negative electrode layer. The end-surface current collectors 11, 12 are laminated on both surfaces of the electrode laminated body 50 in the lamination direction, and the plurality of internal current collectors 20 is included in the interior of the electrode laminated body 50. The other configuration is not particularly limited. FIG. 5 shows a sectional view of the electrode laminated body 50 that is an example. The electrode laminated body 50 shown in FIG. 5 is an electrode laminated body for a bipolar-type lithium-ion secondary battery.

As shown in FIG. 5, in the electrode laminated body 50, a plurality of electrode bodies 56 is laminated. In the electrode laminated body 50, the number of electrode bodies 56 is not particularly limited, and may be appropriately set depending on purpose.

The electrode body 56 includes a positive electrode current collector 51, a negative electrode current collector 52, a positive electrode layer 53, a negative electrode layer 54, and an electrolyte layer 55. The electrode body 56 is formed by overlapping the negative electrode layer 54 disposed on an upper surface of the negative electrode current collector 52 and the positive electrode layer 53 disposed on a lower surface of the positive electrode current collector 51 such that the electrolyte layer 55 is interposed. Moreover, the electrode laminated body 50 is formed such that the plurality of electrode bodies 56 is laminated so as to be connected in series.

The positive electrode current collector 51 disposed on one surface of the electrode laminated body 50 in the lamination direction corresponds to an end-surface positive electrode current collector 11, and the negative electrode current collector 52 disposed on the other surface in the lamination direction corresponds to an end-surface negative electrode current collector 12. Further, the positive electrode current collector 51 or the negative electrode current collector 52 included in the interior of the electrode laminated body 50 corresponds to the internal current collector 20. In FIG. 5, the internal current collector 20 is the positive electrode current collector 51 included in the interior of the electrode laminated body 50.

### End-Surface Insulation Layer 30

The electrode laminated body 50 includes the end-surface insulation layer 30. The end-surface insulation layer 30 is disposed on a part of the end-surface current collector 11. Moreover, the connection portions 22 (the end portions 24) are disposed on the end-surface current collector 11 such that the end-surface insulation layer 30 is interposed, and the end portions 24 and the end-surface current collector 11 are insulated by the end-surface insulation layer 30. In this way, the end-surface insulation layer 30 is disposed between the end portions 24 and the end-surface current collector 11, and plays a role in insulating the end portions 24 and the end-surface current collector 11. Accordingly, the end-surface insulation layer 30 only needs to be disposed on at least a part of the end-surface current collector 11. The end-surface insulation layer 30 may be disposed on the whole of the end-surface current collector 11.

The material of the end-surface insulation layer 30 is not particularly limited, and for example, there are polyimide, polypropylene, polyethylene, polyvinylchloride, polytetrafluorocthylene, and the like. The thickness of the end-surface insulation layer 30 is not particularly limited, and is 5 μm to 300 μm, for example. The disposition method for the end-surface insulation layer 30 is not particularly limited, and for example, a resin tape may be sticked to the end-surface positive electrode current collector 11. Further, a resin sheet may be disposed between the end-surface positive electrode current collector 11 and the end portions 24 of the connection portions 22. Alternatively, a resin material may be applied to the end-surface positive electrode current collector 11.

The end-surface insulation layer 30 may be disposed on the end portions 24. Even when the end-surface insulation layer 30 is disposed on the end portions 24, the end portions 24 and the end-surface current collector 11 can be insulated by the end-surface insulation layer 30. Accordingly, the end-surface insulation layer 30 only needs to be disposed between the end portions 24 and the end-surface current collector 11.

### Side-Surface Insulation Layer 40

The electrode laminated body 50 includes a side-surface insulation layer 40. The side-surface insulation layer 40 is disposed on the side surface 50a of the electrode laminated body 50. Moreover, the connection portions 22 (the extension portions 23) and the side surface 50a of the electrode laminated body 50 are insulated by the side-surface insulation layer 40. In this way, the side-surface insulation layer 40 is disposed on the side surface 50a, and plays a role in insulating the extension portions 23 and the side surface 50a. Accordingly, the side-surface insulation layer 40 only needs to be disposed on at least a part of the side surface 50a. The side-surface insulation layer 40 may be disposed on the whole of the side surface 50a.

The material of the side-surface insulation layer 40 is not particularly limited, and for example, there are polyimide, polypropylene, polyethylene, polyvinylchloride, polytetrafluoroethylene, and the like. The thickness of the side-surface insulation layer 40 is not particularly limited, and is 5 μm to 300 μm, for example. The disposition method for the side-surface insulation layer 40 is not particularly limited, and for example, a resin tape may be sticked to the side surface 50a of the electrode laminated body 50. Further, a resin sheet may be disposed between the side surface 50a of the electrode laminated body 50 and the extension portions 23 of the connection portions 22. Alternatively, a resin material may be applied to the side surface 50a of the electrode laminated body 50.

The side-surface insulation layer 40 may be disposed on the extension portions 23. Even when the side-surface insulation layer 40 is disposed on the extension portions 23, the extension portions 23 and the side surface 50a of the electrode laminated body 50 can be insulated by the side-surface insulation layer 40. Accordingly, the side-surface insulation layer 40 only needs to be disposed on at least one of the extension portions 23 and the side surface 50a of the electrode laminated body 50.

### Battery 100

The battery 100 may include an outer packaging body that houses the electrode laminated body 50. Further, the battery 100 may include an electrode terminal that is connected to the electrode laminated body 50, and may include connection terminals that are connected to the connection portions 22.

The battery in the present disclosure has been described above with use of the embodiment. With the battery in the present disclosure, the outer packaging member having the through-hole is not required, and the connection portion is disposed on the identical surface to the surface on which the end-surface current collector is disposed. Therefore, it is possible to enhance structural efficiency in a simple structure.

What is claimed is:

1. A battery comprising an electrode laminated body, wherein:
end-surface current collectors are disposed on both surfaces of the electrode laminated body in a lamination direction;
an internal current collector is laminated in an interior of the electrode laminated body;
the internal current collector includes a connection portion that is drawn out from a side surface of the electrode laminated body; and
the connection portion extends along the side surface of the electrode laminated body in the lamination direction, and is disposed on an identical surface to a surface on which at least one of the end-surface current collectors is disposed.

2. The battery according to claim 1, wherein:
a plurality of the internal current collectors is laminated in the interior of the electrode laminated body; and
connection portions that are drawn out from the plurality of the internal current collectors are disposed at such positions that the connection portions do not overlap with each other in lamination-directional view.

3. The battery according to claim 1, wherein:
the connection portion is disposed on the at least one of the end-surface current collectors such that an end-surface insulation layer is interposed; and
the connection portion and the at least one of the end-surface current collectors are insulated by the end-surface insulation layer.

4. The battery according to claim 1, wherein:
a side-surface insulation layer is disposed on at least one of an extension portion and the side surface of the electrode laminated body, the extension portion being a portion that is of the connection portion and that extends along the side surface of the electrode laminated body in the lamination direction; and
the connection portion and the side surface of the electrode laminated body are insulated by the side-surface insulation layer.
